(19) United States
(12) Patent Application Publication
(10) Pub. No.: US 2012/0136500 A1
(43) Pub. Date: May 31, 2012

(54) OPERATOR INTERFACE FOR AUTOMATION SYSTEMS

(76) Inventor: Rodney Hughes, Adelaide (AU)

(21) Appl. No.: 13/389,201

(22) PCT Filed: Aug. 6, 2010
(86) PCT No.: PCT/AU2010/000998

§ 371 Date: Feb. 6, 2012

(30) Foreign Application Priority Data
Aug. 6, 2009 (AU) 2009903664

(51) Int. Cl. G06F 1/26; H04L 9/32

(52) U.S. Cl. 700/297

(57) ABSTRACT

Automation system based on communication network, installed to provides facilities for on-site personnel to monitor/control/configure system and connect equipment required to test system. Can automate specific procedures for activities to eliminate human error. Provides necessary commands to the system, other devices and individual functions which enable/disable operation, change operating configuration or send/retrieve certain information. Independent of other devices which provide real time operation of the system to maintain safe and reliable operation of system whilst changes are being made to system regardless of operating condition of other devices. As an independent device to the system, can be standardized at a particular installation and across multiple installations to reduce personnel training and reduce possibilities of human error due to variability of features provided in other devices. Provides authorization facilities to permit activities by authorized operators or only permit communication to system of equipment connected to the device authorized to do so.

### CROSS-REFERENCE TO RELATED APPLICATIONS

This application is a National Stage entry of International Application No. PCT/AU2010/000998 filed 6 Aug. 2010, which claims priority to Australian Patent Application AU 2009903664, filed 6 Aug. 2009, the specifications of which are both hereby incorporated herein by reference.

### FIELD OF THE INVENTION

According to the present invention, although this should not be seen as limiting the invention in any way, there is provided for an automation system a facility or facilities for personnel on site (operators) to monitor and/or control the parameters and/or operating mode of functions on a network and/or provide a facility or facilities for connection of the operator's computer and/or test equipment to the network.

### BACKGROUND

Electrical power supply installations generally have a range of devices for purposes such as individually or severally protecting, controlling, measuring or monitoring the power system and power system equipment. These devices include but are not limited to protection relays, controllers, condition monitoring equipment, meters, sensors, System Control And Data Acquisition (SCADA) equipment, Human Machine Interfaces (HMI), servers, gateways and Remote Terminal Units (RTUs). For the purpose of this invention these devices are generically referred to as intelligent electronic devices (IEDs) due to the general current manufacturing technologies in use. These IEDs are collectively commonly referred to as the substation secondary system or substation automation system (SAS). The IEDs may be physically located elsewhere than in a substation or be of types used for other purposes in any automation system to which this invention equally applies. This invention is described in the context of, but should not be seen to limit the invention in any way to the application in a SAS.

The IEDs may each have one or more functions within them which collectively provide the required operating schemes of the SAS. The SAS may also include devices located as part of the primary equipment, which include but are not limited to items such as circuit breakers, isolators, earthing switches, transformers, instrument transformers, capacitor banks, reactors, static VAR compensators, and so called “flexible AC transmission” devices. The primary equipment itself can therefore also be considered an IED for the purposes of this invention.

Electricity supply is generally considered an essential service which must be provided in a safe and reliable manner at all times and is a prime requirement of the automation functions provided in the SAS. From time to time it is necessary for personnel on site to undertake or undo various activities, as distinct from activities undertaken remotely via a telecommunications link, such as, but not limited to, monitor, control, modify, configure, test, block, enable, substitute, isolate or replace various individual or collective functions or IEDs of the SAS. In addition as a result of these activities, the operation and performance of the rest of the functions and IEDs of the SAS not directly involved in the activities must not be compromised and may themselves need to be controlled, modified or provided with particular information necessary to maintain continued correct operation and performance in consideration of the activities of the personnel. It is therefore necessary to provide one or more facilities for personnel to undertake these activities at various stages of test, commissioning and operation of the SAS and/or the power system. The facilities provided by this invention allow personnel to carry out certain or all aspects of these activities as may be provided in the particular construction of this invention in a safe manner for both personnel safety and the safe and secure operation of the power system.

This invention itself would be considered as an IED in the general sense being based on similar hardware and software requirements as other IEDs mentioned and itself would be connected to and interact with the SAS. However this embodiment is an IED which, in principle but not necessarily, is not itself making or responding to the automatic real time decision and actions of the SAS created by the functions available within the other IEDs except where the operator has used this embodiment to control, monitor or modify the operation, behaviour or other aspects of these other IEDS and functions as may be required for the particularly activities.

IEDs with communication capabilities are available with various communication protocols implemented, which currently use, but does not define or limit in any way the application of this invention, any one or a combination of communication bearers including but not limited to copper, optical fibre or wireless based networking technology with the potential for other media in the future.

The International Electrotechnical Commission standard IEC 61850 (hereafter referred to “the Standard”) was created and is maintained with the aim of providing interoperability between devices of all types. Various companion standards such as but not limited to IEC 61400-25 provide additional references Which for the purpose of this invention are considered to be implicit to the Standard and related to the application of this invention.

The purpose of the Standard is “neither to standardise nor limit in any way the functions involved in the operation of the substation nor their allocation within the substation automation system” (reference IEC 61850 Part 1, Chapter 1). In essence this means that compliant and appropriately configured IEDs with the necessary capabilities can be connected to the network in order to create the real-time operation of the SAS. Rather than the conventional deployment using extensive individual wiring between devices of the SAS, the SAS is therefore able to be created using a communications network currently typically using a TCP/IP Ethernet type Local Area Network (LAN) or Wide Area Network (WAN) as per the communication media technology of the time and requirement of the application. The communications network will include a number of network devices including but not limited to network switches, hubs and routers which therefore also form part of the SAS. The Standard recognises that the communication media, e.g. Ethernet, itself may evolve with different technologies, and hence is generically referred to hereafter as “the network”.

The Standard has enabled interoperable deployment of functions operating with real time performance over a communications network thus providing various benefits according to the requirements, specification and implementation of the particular SAS such as but not limited to the potential abilities for increased functionality, reduced engineering time, enhanced testing methodologies, reduced construction and life time costs, providing more extensive information and an increase in SAS reliability.

The change from an SAS based on individual wire connections between devices to communication with devices using the Standard to create real time operating functions and schemes over a network has introduced a need to provide a new type of facility available on the network for personnel to be able to undertake various tasks and activities for the monitoring and/or operation and/or isolation and/or test of the functions and/or the IEDs and/or the network forming the SAS. This new type of facility must be able to be used in the context of the physical network connection to the IEDs carrying many messages representing different information, commands and responses essential for the correct performance of the SAS in real time. In this context, there is still a requirement to have a facility providing a means other than physical interruption or disconnection for personnel on site to undertake or undo their various activities on the SAS such as but not limited to processes to isolate and/or monitor and/or control and/or create messages on the network in respect of one or more functions available on the network.

It is inappropriate and indeed a risk to the operation of the entire SAS, and potentially the power system at large, for personnel to undertake their activities mentioned in the previous clause by simply physically disconnecting the IEDs from the network as any connection may still be required to be passing essential information for the correct functioning and performance of the SAS. It remains necessary to be able to monitor, control, block or substitute functions and associated messages whilst the SAS is operating in whole or in part with the electrical facility in service or undergoing commissioning or test.

In general, operation and maintenance personnel anecdotally, and by virtue of the experiences and benefits learned in using standardised physical facilities in wire based SAS, require that the operator facilities must be standardised from one location to another, not be dependent on the particular choice of manufacturer of the IEDs performing the automation functions of the SAS and indeed be independent of the experience of potential third party SAS designers or integrators in providing such operational facilities and procedures as required by the operation and maintenance personnel. This requirement is essential so as not to create inconsistent mechanisms and procedures, or due to absence of the required facility even inability, to carry out certain activities on the functions and SAS.

Certain activities by personnel must be done in strict sequences or subject to certain conditions required or imposed by the operational state and performance of the SAS and/or power system.

The Standard itself has defined various commands, modes, information and messages as capabilities specifically for the purpose of controlling the SAS for various purposes including personnel based activities. The Standard however does not define why, where, how or to what extent, if at all, these capabilities are implemented in any particular SAS. This invention recognises that such capabilities of the Standard may be implemented within the IEDs other than this embodiment. However this embodiment addresses the needs of providing a facility and means for operators to access the SAS and undertake various activities in consideration of the experiences and limitations of the prior art as described, as well as in consideration of the objectives of this invention.

SAS based on hard wired connections between devices and equipment typically have various facilities which allow personnel to carry out their activities in a safe manner whilst not causing a risk to correct operation of the rest of the system. Such wire based systems typically have a range of operator interface facilities including but not limited to test blocks, isolating links, selector switches and selector buttons for various purposes of test and operating mode configuration. These facilities are generally part of the physical path for the particular signal being passed from one device to another as generically shown in Error! Reference source not found. as a partial concept of the implementation of typical components of the SAS and described.

Asset owners generally standardise on a particular brand and configuration of links and switches as recognisable facilities for all the required activities defined in the operational procedures independent of the IEDs chosen for the SAS. In addition there are generally strict procedures, certain required system conditions that must exist at various steps in the procedures and training for personnel before carrying out activities. Despite even these measures, it remains possible that personnel make errors in sequencing, have not confirmed correct conditions for proceeding, use the incorrect facility in undertaking their activity, may be confused by the form or process of using the particular facility provided, or may not be able to undertake the full requirements of the activity due to absence or limitation of the facility as implemented. In such circumstances, there is potential for equipment damage, power system blackouts, injury and death.

In some cases, SAS are provided with facilities which individually or collectively enable the operator to carry out or undo actions to isolate, disconnect or disable individual or collective functions or IEDs of the SAS. These facilities are generally by means of test links and/or switches in predefined standard configurations.

In some cases, facilities are provided as indications to personnel of the operating mode or test state of the SAS elements such as but not limited to the visible position of links, indicating lights and displays.

In some cases, facilities are provided as a means for temporary connection of test equipment, computers and monitoring equipment to the SAS and/or its individual elements.

In some other cases, the mechanisms to provide the facilities for the personnel to undertake their activities may be implemented within the IEDs, other than via this embodiment, connected to the network which provide the automated functions of the SAS. Such implementations may by example consist of using an HMI or the IEDs themselves which provide the automation functions of the SAS as described in the following.

In the case of operator interfaces using the HMI, if it is provided at all, the industry anecdotally considers that HMI devices are generally unreliable items of equipment subject to failure or theft more so than other specific automation IEDs designed for fixed installation and operation in an electrical facility. The HMI does provide a means for monitoring and controlling certain, but not necessarily all, predefined aspects of the SAS. The HMI generally does not provide the mechanisms, or equipment connection facilities, for testing of functions or IEDs. Indeed the variability of some actions required to be carried out by the personnel particularly during test activities will generally preclude predefining all the implementation requirements within the HMI with the need for some other facility for the operator to undertake the complete range of activities. In some cases the use of the HMI may be restricted to certain personnel only for certain tasks. Hence the HMI will not necessarily provide the full requisite of facilities for all activities of all personnel. The existence of the HMI and its availability for use by the operators is therefore generally not presumed or relied on by the industry for the purposes of all activities by all personnel.

In the case of providing operator interfaces using the IEDs providing the automation functions of the SAS other than this embodiment, there are a number of circumstances where correct operation of the rest of the SAS or of testing the IED itself may need independent facilities for activities of the personnel such as to permit testing or replacement of IEDs in the SAS.

In one such circumstance, some types of IEDs provide integrated facilities such as but not limited to switches, buttons and indicators relative to the mode of operation of the IEDs and the functions they contain. Whilst serving a similar capability as the user controlled interface device for interacting with functions in the IED, these facilities are not independent of the IED itself. Hence in case of failure of the IED or if it is taken out of service for testing or replacement of the IED, the necessary control of the IED as well as for other IEDs of the SAS may be lost causing the operation of the rest of the SAS to be impaired or compromised in some way or to operate inappropriately.

In another circumstance, the choice of manufacturers for IEDs to provide particular functions for the SAS may affect the way in which the activities are carried out using the buttons or menu systems integrated with the IED which can lead to confusion or errors by the personnel or even limit the ability to carry out their activities. Whilst some IEDs may provide one or more of these functions integrated with the IED device, this will likely be a different facility, mechanism or process for each manufacturer or indeed may not be implemented fully by particular manufacturer. Hence depending on the chosen brand of IEDs to suit the particular SAS operational needs at each installation, the facilities integrated with the IED will not necessarily be consistent and hence may lead to confusion as to where these facilities are located in the SAS. The variety of IED vendor specific facilities may be confusing to the operator due to different layouts and descriptions of the control and isolation facilities which could lead to unsafe actions. Furthermore some asset owners have operating procedures which restrict direct physical access to and control of the IEDs for certain users and hence a facility is required independent of the secured IEDs.

In another circumstance where the IED provides its own integrated facilities and it is to be replaced with another IED, the mode of operation of the replacement IED may not be known or may take some time to be correctly established when connected to the network. During this time the rest of the SAS may be at risk of incorrect or no operation pending the new IED coming into full operation with the SAS.

In some cases personnel may connect test equipment and computers to the network by making connections directly to the LAN switches of the network. This requires the connection ports of the switches to be left in a state referred to as ‘open’ to permit connection of equipment as required. General security philosophy requires that ports should not be left open as this presents a potential access point as a cyber-security breach to the LAN. These switches and ports are also generally located inside the cubicles where the IEDs are installed and hence with potential exposure to electrical hazards and difficulty of working in restricted space. Direct access to these switches also creates the additional and generally unacceptable risk of personnel disconnecting the wrong connections and disrupting the SAS operation, performance or reliability. Therefore for various security and safety reasons these connection points may have restricted access and connectivity by physical means and/or policy.

### OBJECT OF THE INVENTION

It is an object of the present invention as an interface unit device to provide a means for personnel to have direct physical access, connection and interaction with the SAS, as distinct from remote access via a telecommunications link, and requiring to undertake one or more of the following, but not limited to, activities associated with an SAS network with the necessary access permissions to the network of monitoring the state of functions and parameters on the SAS, configuring functions and/or IEDs into a different operating or test mode, connecting computers and/or test equipment to the network.

It is a further object of the present invention to overcome, or at least substantially ameliorate, the disadvantages, risks, hazards and shortcomings of the prior art through the use of facilities suited to the implementation of LAN based SAS.

With the above objectives in mind the, the advantage of this device is that it provides a standard interface and control facility which may be used regardless of the types and brands of other devices on the network and the features and capabilities they provide as required by the particular requirements, specification and implementation of the SAS.

Another advantage of this device is that this provides clarity to the operators and hence operational safety by having one recognisable facility for these requirements throughout the entire SAS and consistent from one location to another.

Another advantage of this device is that this device can be configured to provide the operator interface controls, isolation, indications and connectivity as required by the operational procedures of the asset owner to assure safe and correct sequencing of individual actions for the particular activity.

Another advantage of this device is that it can be added to or removed from any SAS at any location(s) in the network without impacting the overall design of the SAS and network topology due to the principles of IEC 61850 allowing facilities to be freely allocated through the SAS. This allows optimisation of the number of individual test or isolating points and provides for easier operation by the users at secure controlled locations not constrained by the location of the electrical wiring of the SAS and the location of the IEDs as is the case with conventional SAS.

Another advantage of this device is that it does not introduce any additional latency in the normal operation of the SAS communications between devices as it is not in series with the normal signal traffic over the SAS network as is the case with conventional test facilities as shown in FIG. 1.

Another advantage of this device is that it does not reduce the overall reliability, availability, maintainability and performance of the SAS being implemented as an IED connected to the network. This is unlike wire based SAS facilities such as links and switches which are physically in series with the signals being passed between IEDs for the automation functions of the SAS and hence reduce overall reliability with their own potential failure modes in addition to those of the IEDs.

Another advantage of this device is to improve reliability and availability of the SAS to perform its designed purposes. Wire based SAS isolation, test or monitoring facilities or IEDs in any SAS are sometimes inadvertently left in a non-operating or incorrect state for correct operation of the SAS. This embodiment can monitor functions and IEDs of the SAS to provide personnel, locally, or remotely via the WAN, with indications of not only status of itself but also of the modes and operating conditions of the functions and IEDs in the SAS.

Another advantage of this device is that the number of instances of this interface unit at a particular site may be optimised to suit the operational requirements of the asset owner and personnel. As generally shown in Error! Reference source not found., the number and location of the interface units throughout the SAS can be such as to provide access to the whole or part of the SAS according to the required activities and actions such as interacting with one or more particular functions or IEDs on the SAS and allowing connection of required equipment at appropriate locations for monitoring and/or test of the functions and IEDS.

Another advantage of this device is that the number of instances of the device can be chosen to suit the physical access requirements of the network and equipment being operated. The SAS may be implemented using multiple LANs and/or the LAN may be segregated using Virtual LAN (VLAN). The device may be implemented relative to the network configuration to access the entire SAS, to be connected to more than one network or restricted to the particular VLAN for the section of the SAS to be accessed. Multiple instances of the device can therefore be used for different purposes in different locations on the network.

Another advantage of this device is that the unit itself can be replaced with another unit without disruption of the ongoing operation of the SAS unlike conventional SAS test and isolation facilities.

Another advantage of this device is to provide direct confirmation to personnel that the commands sent to the functions and IEDs have been completed. This device can monitor responses from or interrogate the functions and IEDs for confirmation that they are in the correct required state.

Another advantage of this device is that the entire SAS can be managed, controlled and configured to maintain correct operation in consideration of the operator activities on the whole or part of the SAS. The interface unit can be implemented with predefined configurations of the SAS elements to be implemented in appropriate sequences as may be required under certain operator activity scenarios. As an example a certain function or IED may need to be placed in a particular predefined mode by the interface unit whilst the operator is undertaking specified tasks or controls on the same or other functions.

Another advantage of this device is to improve the accuracy and safety for the operator in carrying out the activities by automatically performing a predefined sequence of commands and actions in order to safely and completely perform the tasks and hence eliminate operator error in incorrect, out of sequence steps or omitting steps in the required process.

Another advantage of this device is that it will not degrade the cyber security resilience of the SAS. The use of the interface unit as the point of connection means that ports on the network switches do not need to be left open as a cyber-security risk. Connection of PCs and test equipment via the interface unit can be controlled by security measures within the unit such as passwords and other authentication processes to allow controlled authorised connection to the network.

Another advantage of this device is the ability to retain some degree of familiarity of use of the physical facilities typically used in wire based SAS operation. The interface unit may have external switches, links, push buttons or indicators connected to the unit as previously used as the mechanisms by which the personnel carry out certain activities.

Another advantage of this device is that it may improve the overall functionality or implementation of the SAS by being implemented as part of the real-time operation of the SAS itself. Where it is acceptable to forgo the benefits based on this unit being independent of IEDs providing the automation functions, the device being itself potentially constructed using similar hardware and software systems as the other IEDs on the network, it may also itself have certain functions for provision of the non-personnel based operation of the SAS.

Another advantage of this device is to reduce the requirement for operators to directly operate IEDs. As each SAS may have a number of different IEDs from different manufacturers, there is a risk of mistakes and errors in using the controls integrated with the IEDs. The user controlled interface facilities can be provided independently of the direct access and control of the IEDs in the SAS in order to retain operational security of the SAS and the IEDs themselves which may also be an operational policy of the asset owner. This extends to being located remotely from the location of the IEDs in contrast to wire based systems typically requiring them to be located near the IEDs and within the wiring of the SAS.

Another advantage of this device is that it can be manufactured with the same quality and service requirements of other IEDs of the SAS and does not necessarily require development of new hardware and software platforms as currently used by the manufacturers of the other functions and IEDs of the SAS.

Another advantage of this device is that connection and disconnection of PCs and test equipment to/from the network SAS can be done in a safe and secure manner. As the connection point for the equipment is not associated with the multiple connections to the network switches often located inside the panels along with other electrical connections and terminals, the operator is not able to interfere or disrupt the normal connections of the network which would otherwise impair, compromise or cause inappropriate operation of the SAS.

Another advantage of this device is that it reduces the need for personnel training in the operation of the SAS as it provides standardised facilities independent of the choice of manufacturers of the other IEDs.

Other objects and advantages of the present invention will become apparent from the following description, taking in connection with the accompanying drawings, wherein, by way of illustration and example, an embodiment of the present invention is disclosed.

### SUMMARY OF THE INVENTION

According to the present invention there is described a method of personnel using the operator controlled interface unit to access and interact with a substation automation system (SAS), the SAS having:
a. a SAS network; and
b. at least a first IED connected to and in communication with the SAS network and having at least a first function; and
c. a user controlled interface as described by this invention connected to and in communication with the network, the interface being independent of the at least first IED;

In preference and subject to the requirements of the SAS, the SAS may include an at least second function connected to the network.

In preference, the SAS uses IEC 61850 mechanisms in order to send and receive messages via the LAN for the purposes of providing information, signals, commands and responses to and/or from the IEDs forming the SAS.

In preference, the IED providing the at least first function is IEC 61850 compliant.

In preference, the user controlled interface is IEC 61850 compliant.

In preference, the user controlled interface allows signals to be sent to or from the at least first function or detected as being sent to or from the at least first function and the response of the at least first function without necessarily taking any specific control, command or disruption of the at least first function, the IED in which it is located or the network.

In preference, the method includes one or more of the steps of a user operating the user controlled interface, or operating the facilities connected to the user controlled interface for the purposes of modifying the operation of the functions, IEDs or SAS of:
a. authorising the user to use the controls integrated with the interface unit
b. authorising connection of other user's equipment to communicate with the SAS; and/or
c. connecting to the network PCs and/or other test equipment using communication ports via the interface unit for the purposes of interaction with the at least first function; and/or
d. connecting links, switches, indicators or such other physical facilities for the operator to interact with the at least first function; and/or
e. changing a parameter of the at least first function to a different value; and/or
f. enabling or disabling or modifying the mode of operation of the at least first function and or the IED in which it is located; and/or
g. enabling or disabling inputs to and/or outputs from the at least first function from the network; and/or
h. observing that status and/or operation of the at least first function; and/or
i. observing and/or record and/or analyse messages on the network; and/or
j. creating signals on the network so as to test the operation of the at least first function and/or the network itself using equipment connected by the user to the user controlled interface; and/or
k. creating signals on the network to manage the operation and performance of the at least second function whilst the user is undertaking activities associated with the at least first function.

### BRIEF DESCRIPTION OF THE DRAWINGS

By way of example, an employment of the invention is described more fully hereinafter with reference to the accompanying drawings, in which:

FIG. 1 is a diagrammatic overview of isolation-test links in a wire based system;

FIG. 2 is a view of the interface unit of the present invention identifying some of the features provided on the interface unit;

FIG. 3 is diagram of a number of IEDs and a number of instances of this invention connected to an SAS network.

### DETAILED DESCRIPTION OF THE INVENTION

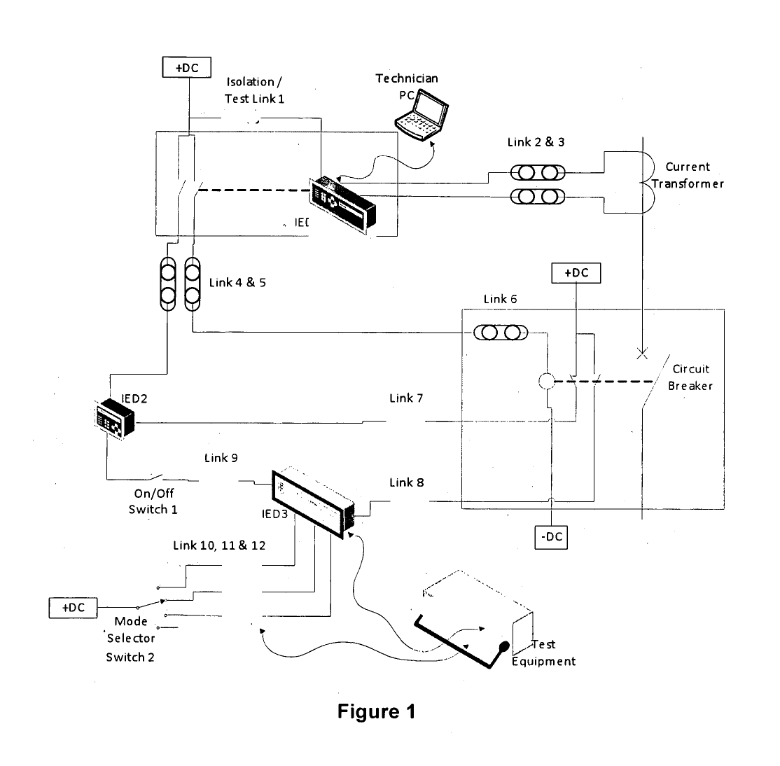

Without defining or limiting the application or implementation of this invention in any way, FIG. 1 is a generic concept diagram of a wire based SAS with direct current (DC) auxiliary supply with facilities such as test and isolating links, selector switches/buttons to modify the scheme operation and/or provide monitoring or indication of status of functions on the SAS. The isolation and test links or the on/off switch physically interrupts the SAS signal between the devices, or the selector switch physically redirects the signal. Without limiting the types of facilities as may be provided in any facility or restricting the application of this invention in any way, links may be positioned in the SAS in various locations. Links positioned in respect of an IED similar to Link 1 provides or removes power from the IED completely to effectively enable or disable the IED. Links similar to 2 and 3 provide the ability to safely isolate analogue inputs to IEDs and/or provide the ability to connect equipment to monitor and/or inject signals into the IED for test purposes. Links such as 4 and 5 provide the ability to isolate outputs from the IED and/or provide the ability to monitor the operation of the outputs. Links such as Link 6, 7 or 8 provides the ability to disconnect signals to or from items of equipment and/or monitor and/or test operation of the equipment. Links such as Link 9 provides the ability to disconnect, monitor or test signals between IEDs. Switches such as Switch 1 provide the ability to switch on/off or enable/disable certain functions of the SAS. Switches such as Switch 2 provide the ability to enable particular modes of functions to be selected. Links such as Links 10 to 11 provide the ability to disconnect, monitor or test the operation of the switch and modes of the functions. In wire based systems the PCs may be directly connected to the IEDs or via a network. Test equipment may be connected to the test points provided with the links or other locations and/or to the IEDs directly of via the network;

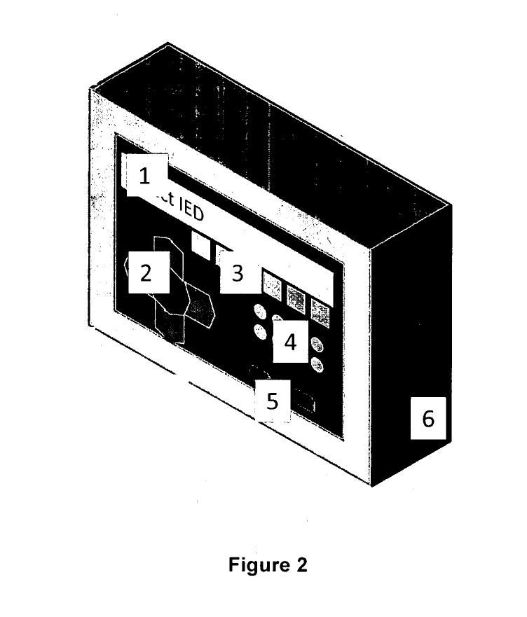

Without limiting the shape, manufacture, materials, location of the features or any other physical properties of the present invention or the absence or number of features provided on the invention, FIG. 2 is a generic concept of the features provided on the interface unit. Features such as type 1 provide a display of various information of the interface unit and/or the SAS. Features such as type 2 provide control of the menu and selections available on the interface unit. Features such as type 3 provide individual control or selection of functions available on the interface unit or in the SAS. Features such as type 4 provide indications of specific information or conditions available in the interface unit or in the SAS. Features such as type 5 provide the ability to connect the interface unit to one or more ports on the network and/or connect one or more PCs or test equipment to the unit. Features such as type 6 (not specifically shown) provide the ability to connect external components such as links, switches, buttons and indicators to the interface unit.

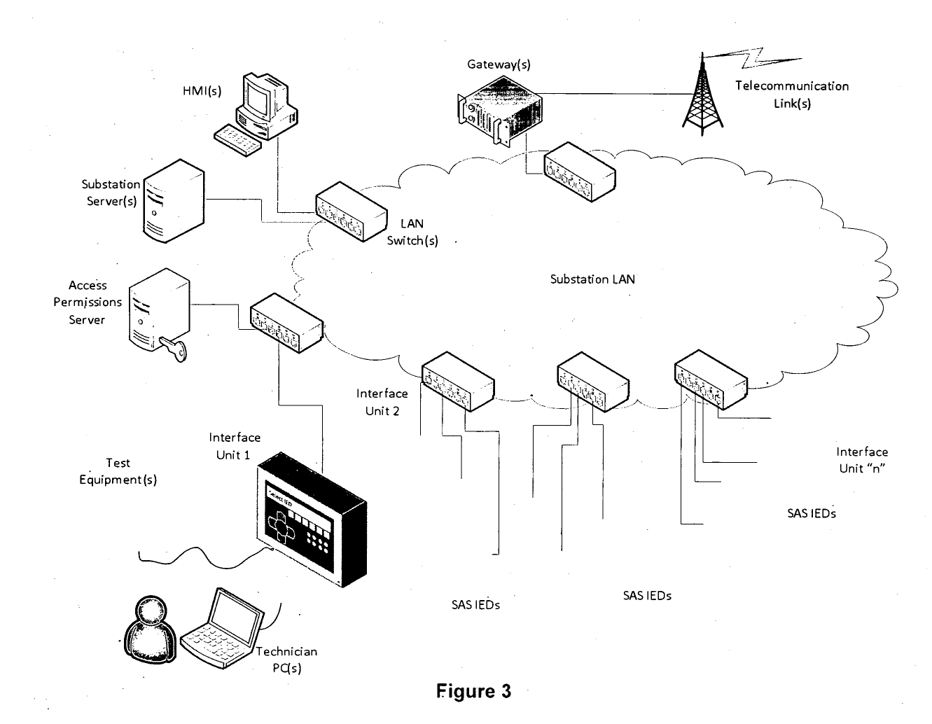

FIG. 3 is a generic concept diagram of a number of IEDs and a number of instances of this invention connected to an SAS network. Without limiting the application or use of this invention, this diagram indicates that the user interface facilities can in principle be connected anywhere to the network subject to appropriate configuration of the network and connection points. Any number of interface units may be connected to the network to suit the operational access requirements of the system and operators. PCs used by the technicians and test equipment may be connected to any of the interface units;

As the facility of the present invention operates in the virtual environment over a network, they can be connected to the network at any appropriate location(s) with as many instances as may suit the operational requirements of the asset owner and/or the complexity of the capabilities provided by the interface unit in respect of any one or combination of IEDs and functions.

Due to the variety of SAS implementations generally necessitating interoperability of multiple IEDs to exchange and use messages, the interface device must be able to be used with IEDs on the network which is in the context of interoperability and compliance to IEC 61850.

The method of use of this embodiment is seen as including but not limited to the following scenarios in which the user controlled interface is in communication with the IEDs via the SAS network. By being independent, the positioning within the system is not relevant other than it and the network is configured to provide communications with the functions on the network.

The first described scenario for this embodiment is where the interface unit may be preconfigured to provide indication to the operator of the state or values of various functions either via the indicator(s) integrated with the interface unit and/or externally to the interface unit via indicators or equipment connected to the interface unit. This may involve use of the integrated controls of the interface unit or any external physical components such as links, switches or buttons connected to the interface unit preconfigured to select the particular information required. The interface unit may be preconfigured to subsequently provide the information to the operator either via the indicator(s) integrated with the interface unit and/or externally to the interface unit via indicators or equipment connected to the interface unit.

The second described scenario is where the operator wishes to use any external physical components such as links, switches or buttons connected to the interface unit to operate the SAS. Changing the state of these components is to cause the SAS to change the operational criteria of certain functions of the SAS such as an operating threshold, enable/disable the function, or change the mode of operation of the function. The pre-configuration of the interface unit will establish if changing the state of these external components controls will only cause changes to the SAS only subject to specific identification and authorisation of the operator so as to prevent inappropriate operation of the SAS by unauthorised persons as deemed by the asset owners operational and security policies and procedures. The interface unit must be preconfigured to detect the change of state of these external facilities and accordingly to issue the necessary signals and commands to the SAS and functions to complete the required action(s) according to the predefined sequence for that particular external input to the interface unit. The interface unit must be pre-configured to perform individual and sequences of actions such as to enable certain functions, disable certain functions, changing parameters of certain functions and selecting the operating mode of certain functions to behave in a predefined manner when receiving information from the function specifically intended by the change of state of the external component. The interface unit may be preconfigured to subsequently provide indication to the operator of the result of these actions either via the indicator(s) integrated with the interface unit and/or externally to the interface unit via indicators or equipment connected to the interface unit.

The third described scenario, in a similar scenario as the second scenario, is an operator in the substation who wishes to use the controls integrated with the interface unit such as buttons, switches and menus to monitor or operate the SAS or individual functions and information available in the SAS. The pre-configuration of the interface unit will establish which if any of these controls are enabled only subject to specific identification and authorisation of the operator so as to prevent inappropriate operation of the SAS by unauthorised persons as deemed by the asset owners operational and security policies and procedures. The interface unit must be preconfigured to detect the use of these controls and accordingly to issue the necessary signals and commands to the SAS and specific functions to complete the required action(s) according to the predefined sequence for that particular control. The interface unit must be pre-configured to perform individual and sequences of actions such as to enable certain functions, disable certain functions, changing parameters of certain functions and selecting the operating mode of certain functions to behave in a predefined manner when receiving information from the function specifically intended by the operation of the control. The interlace unit may be preconfigured to subsequently provide indication to the operator of the result of these actions either via the indicator(s) integrated with the interface unit and/or externally to the interface unit via indicators or equipment connected to the interface unit.

The fourth described scenario is an operator who wishes to connect a PC or test equipment to the SAS for the purpose of monitoring, operating or testing functions, IEDs or the network. The interface unit may be preconfigured to use its identification and authentication mechanisms to validate and thus permit or deny communications of the connected equipment with the SAS. The interface unit is subsequently essentially transparent to the use of the PC or test equipment such that they operate essentially as directly connected to the SAS network.

The fifth described scenario is where the SAS needs to be physically modified such as to replace an IED, add or remove IEDs. In this scenario, other IEDs and functions may need to be configured in a certain manner as predefined by the configuration of the interface unit or by the PC or test equipment connected to the interface unit. The interface unit will establish the necessary configuration of any IED to be removed and the rest of the IEDs in the SAS so as to maintain correct operation of the SAS during the modifications. In this scenario the interface unit will be used in accordance with one or more of the previous scenarios to place the SAS into the required condition that will permit the process to be undertaken safely and correctly and subsequently return the entire SAS to its normal operating state.

The sixth scenario is where IEDs on the SAS are to be reconfigured by software or firmware modification necessitating taking the IED out of normal service in the SAS. In these circumstances it may be necessary as with physical modifications to configure the other IEDs in the SAS in certain modes so as to allow the relevant IEDs to be reconfigured without compromising the correct operation of the SAS during the process. In this scenario the interface unit will be used in accordance with one or more of the previous scenarios to place the SAS into the required condition that will permit the process to be undertaken safely and correctly and subsequently return the entire SAS to its normal operating state.

Although the invention has been herein shown and described in what is conceived to be the most practical and preferred embodiment, it is recognized that departures can be made within the scope of the invention, which is not to be limited to the details described herein but it is to be accorded the full scope of the appended claims so as to embrace any and all equivalent devices and apparatus.

What is claimed is:

1-7. (canceled)

8. An operator controlled interface unit configured to access and interact with a substation automation system or SAS, the SAS having:
an SAS network;
at least one intelligent electronic device or IED connected to and configured to communicate with the SAS network and having an at least first function; and
a user controlled interface connected to and configured to communicate with the SAS network, the user controlled interface being independent of the at least one IED.

2. The system of claim 8, wherein the SAS comprises an at least second function connected to the SAS network.

3. The system of claim 8 wherein the SAS is configured to utilize IEC 61850 mechanisms in order to send and receive messages via a LAN to provide information, signals, commands and responses to or from, or to and from, the at least one IED of the SAS.

4. The system of claim 8 wherein the at least one IED having the at least first function is IEC 61850 compliant.

5. The system of claim 8 wherein the user controlled interface is IEC 61850 compliant.

6. The system of claim 8 wherein the user controlled interface is configured to allow signals to be sent to or from the at least first function or detected as being sent to or from the at least first function and the response of the at least first function without necessarily taking any specific control, command or disruption of the at least first function, the at least one IED in which it is located or the SAS network.

7. The system of claim 8 wherein the user controlled interface is configured to accept a command to modify operation of the at least first function, the at least one IED or SAS to authorize a user to use controls integrated with an operator controlled interface unit;
authorize connection of other user's equipment to communicate with the SAS;
connect to at least one network personal computer or other test equipment, or said at least one network personal computer and other test equipment, through communication ports via the operator controlled interface unit to enable interaction with the at least first function;
connect links, switches, indicators for the user to interact with the at least first function;
change a parameter of the at least first function to a different value;
enable or disable or modify a mode of operation of the at least first function or the IED, or the mode of operation of the at least first function and the IED;
enable or disable input to or outputs from, or inputs to and outputs from, the at least first function from the network;
observe that status or operation, or status and operation, of the at least first function;
observe or record or analyze, or observe and record and analyse messages, on the SAS network;
create signals on the SAS network to test operation of the at least first function or the SAS network itself, or the at least first function and the SAS network itself, using equipment connected by the user to the user controlled interface;
create signals on the SAS network to manage operation and performance of the at least second function whilst the user is undertaking activities associated with the at least first function.
